(19) United States
(12) Patent Application Publication
(10) Pub. No.: US 2003/0146580 A1
(43) Pub. Date: Aug. 7, 2003

(54) Valve seal assembly with multiple leg retainer

(76) Inventor: Timothy Alan Hegemier, Avilla, IN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/061,132

(22) Filed: Feb. 1, 2002

(51) Int. Cl. F02F 11/00

(52) U.S. Cl. 277/502

(57) ABSTRACT

A radially compliant valve stem seal assembly for an internal combustion engine includes a metallic retainer having a plurality of circumferentially spaced, axially depending legs. Each of the legs includes at least one radially inwardly depending protuberance adapted to engage a valve guide surface. The legs are arranged and disposed on the retainer to be radially flexible, yet axially stiff, to balance forces of installation against those of securement of valve stem seal assembly over a wide valve guide diameter tolerance range. In one disclosed embodiment, the retainer has three separate circumferentially spaced legs, each including a single dimple in its structure. The dimples are adapted to provide the only direct contact of the legs with the valve guide circumference. The retainer legs are adapted to flex radially outwardly, and produce a spring tension between the dimples and the guide for maintaining the dimples in engagement with the valve guide.

### BACKGROUND OF THE INVENTION

1. Field of Invention

The present invention relates to valve stem seal assemblies adapted to be installed over valve stems reciprocally movable within valve guides of internal combustion engines. More particularly, the invention relates to seal assembly retainers incorporating specially designed retention mechanisms for securement of such assemblies to valve guides.

2. Description of the Prior Art

Those skilled in the art will appreciate the manner in which intake and exhaust valves are employed in cylinder heads of internal combustion engines. Such valves, supported for reciprocal motion within valve guides, typically include integral elongated stems extending away from the engine cylinder heads, the ends of the stems interacting with rotating overhead cams for cyclic or repeated opening and closure of the valves against the force of valve return springs during the combustion cycle.

Obviously, in order to permit unobstructed reciprocal movement of the stem in the guide, some mechanical clearance must exist between the valve guide and the moving stem. A plurality of valve stems move reciprocally to and from the cylinder head, each within its individual guide, and so-called valve stem seal assemblies are used to seal against leakage of oil through a mechanical clearance path between each annular engine valve guide and its associated valve stem.

As is well known, the intake port of a combustion chamber is opened and closed by the reciprocating motion of at least one intake valve, which in turn is driven by the rotary motion of a cam, the latter being affixed to and rotatable with an engine camshaft. The intake valve permits fuel mixed with air to flow into the combustion chamber. In addition, most internal combustion engines have at least one exhaust valve and associated exhaust port for releasing expended combustion gases to the atmosphere. Typically, intake and exhaust valves are of similar construction, and both include stems integrally affixed to the valves.

In the typical engine, a valve stem seal assembly is fitted over or atop each valve guide, wherein each seal assembly includes a retainer frictionally mounted to an associated valve guide. Each valve stem seal assembly normally has two primary parts: 1) an elastomeric oil seal for controlling leakage of oil between the valve stem and guide as noted, and 2) a structural cylindrical retainer mounted atop of the valve guide to hold the oil seal in place.

Although valve stem seal elastomer body design, performance, and construction issues have seen much progress in recent years, the installation and securement of valve seal assemblies remain areas in need of improvement. For example, there remains a recognized need for more radially flexible valve stem seal retainers that can accommodate valve guides having diameters machined to tolerances as widely varying as plus or minus 0.010 inch. In fact, where guide-mounted seals are used, and radial flexibility is required, a ring and band seal has been the only suitable option. Unfortunately, however, although a ring and band seal is flexible in a radial direction, it lacks axial rigidity, and at maximum interference with a valve guide, the seal assembly often collapses during attempted installation over the guide.

The valve stem seal retainer of the present invention addresses the noted installation issues by incorporating a radially flexible, yet axially stiff, design to facilitate installation over a wide variety of valve guide diameters. Moreover, the structure is easily tailored to provide for proper retention of a valve stem seal assembly to a valve guide under a variety of installation and retention load requirements.

### SUMMARY OF THE INVENTION

The disclosed invention is a two-piece valve stem seal and retainer assembly for an internal combustion engine. A plurality of such assemblies is contemplated for use in an engine, each designed for insertion over an engine valve guide for continuous engagement with an associated reciprocally moveable valve stem. The elastomer seal body includes a circumferential aperture containing at least one radially inwardly directed sealing lip adapted to engage the stem to minimize the escape of oil lubricant from the engine, particularly along a path between the valve guide and the reciprocally moving valve stem seal.

In one described embodiment, the seal body contains an annular groove adapted to receive an end wall of an upper extremity of the retainer. The retainer, formed of metal, comprises a cylindrical body containing a plurality of axially depending, circumferentially spaced legs. Each of the legs includes at least one radially inwardly depending protuberance, such as a dimple, adapted to engage an external circumferential valve guide surface. The legs are arranged and disposed about the retainer to be radially flexible, yet axially stiff, so as to balance forces of installation against those of securement and retention of the valve stem seal assembly over a relatively wide valve guide diameter tolerance range.

The nature of the retainer permits its utilization with both assembled and adhesively bonded seal bodies. In one disclosed embodiment, the retainer has three circumferentially spaced legs, each including a single dimple in its structure. The dimples are adapted to provide the only direct contact of the legs with the valve guide surface. The retainer legs are adapted to flex radially outwardly under a radially directed spring tension, so as to maintain a contact force, i.e. frictional retention force, between the dimples and the guide, and to hold the dimples in constant engagement with the valve guide.

The contact force between the dimples and the guide is based upon amount of interference; the interference is based on dimensional tolerance between the internal diameter circle of the dimples and the outside diameter of the valve guide. The amount of force/tension can be adjusted by varying dimensions including widths and or material thicknesses of the retainer, including its legs. Finally, the profile of the dimples can be varied to provide more or less aggressive “bites” against the circumference of the guide.

### BRIEF DESCRIPTION OF THE DRAWING

FIG. 1 is a cross-sectional view of a prior art valve stem seal assembly shown installed over a valve guide of the type incorporated in an internal combustion engine.

FIG. 2 is a cross-sectional view of one described embodiment of a valve stem seal retainer of the present invention.

FIG. 3 is a perspective view of the described embodiment of FIG. 2.

FIG. 4 is a cross-sectional view of the same described embodiment, taken along lines 4-4 of FIG. 2.

### DETAILED DESCRIPTION OF PREFERRED EMBODIMENTS

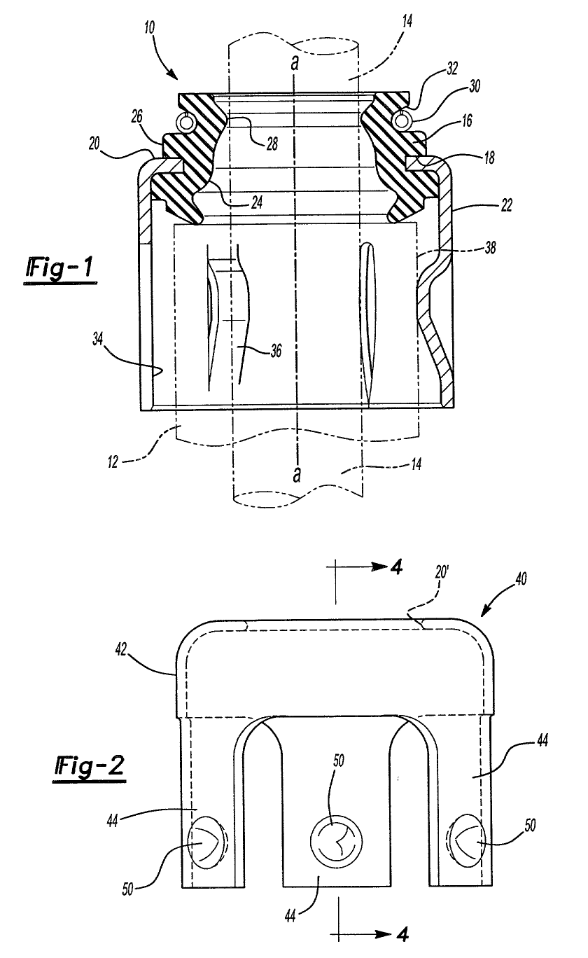

Referring initially to FIG. 1, a prior art valve stem seal assembly 10 is adapted to be mounted over an annular valve guide 12 (shown in phantom) of an internal combustion engine (not shown). An elongate cylindrical valve stem 14 (also shown in phantom) is supported within the valve guide, the stem 14 being positioned longitudinally (or vertically) for reciprocal movement along an axis a-a that also passes through the axial center of the cylindrical assembly 10.

The assembly 10 includes a resilient valve stem seal 16, which in the described embodiment is defined by an elastomeric annular body adapted to sealingly engage the elongate valve stem 14. For securement of the seal 16, the exterior seal body thereof incorporates a circumferentially extending exterior groove 18 adapted for receipt of an annular end wall 20 of a cylindrical metallic valve seal retainer 22. Thus, it will be appreciated that the retainer 22 is adapted to retain and support the resilient seal 16 atop the annular valve guide 12.

The elastomeric annular body of the seal 16 includes interior and exterior surfaces 24 and 26, respectively. Within its interior surface 24, the seal 16 includes a circumferentially extending primary sealing lip 28 adapted to engage the exterior circumferential surface of the stem 14 for limiting and or otherwise controlling movement of crankcase oil along a mechanical clearance path between the stem 14 and the valve guide 12. Thus, undesirable entry of oil into the combustion chamber may thereby be avoided, as will be appreciated by those skilled in the art. Via the exterior groove 18, the end wall 20 of the seal retainer 22, as shown, frictionally and circumferentially supports the seal 16. To enhance sealing effectiveness between the lip 28 and stem 14, a garter spring 30 is positioned within a groove 32 that encircles the exterior surface 26. The spring 30 is positioned radially outwardly of the primary sealing lip 28, and imparts a radial compression force against the lip 28 and ultimately against the reciprocally moving valve stem 14.

Referring now to the valve stem seal retainer 22, and particularly to its function of frictionally retaining the assembly 10 on the valve guide 12, it will be appreciated by those skilled in the art that wide tolerances in machining of the valve guide 12 can create assembly to valve guide retention issues. Thus, in the prior art structure displayed, the retainer 22 is essentially a cylindrical unitary body of metal 34 that contains a circumferentially arranged series of radially inwardly projecting, axially oriented detents 36. The detents 36 are resilient, and are adapted to frictionally engage the outer circumferential surface 38 of the guide 12. Moreover the resiliency of the detents 36 is adapted to accommodate tolerance variations. In many instances, however, the amount of tolerance satisfactorily accommodated by the prior art retainer 22 of FIG. 1 is relatively low.

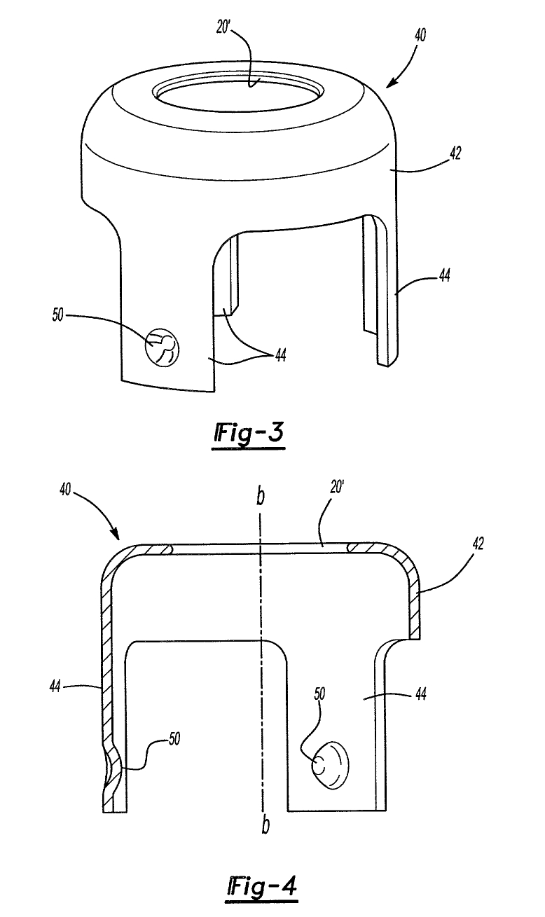

Referring now to FIGS. 2-4, an improved retainer 40 incorporates an upper annular body 42 having an annular end wall 20′ as shown for supporting a resilient seal 16 (FIG. 1). The retainer 40 is uniformly and circumferentially disposed about the axis b-b, as depicted in FIG. 4, the axis b-b being analogous to the axis a-a of FIG. 1. A plurality of circumferentially spaced, axially extending legs 44 depend from the upper body 42 of the retainer 40. In the described embodiment, the legs 44 are circumferentially disposed in a uniformly spaced manner about the body 42. There are three legs in the described embodiment.

Each of the legs 44 incorporates at least one radially inwardly extending protuberance 50, which in the described embodiment is in the shape of a hemispheric depression or three-dimensional bump, hereinafter called a dimple. Such a protuberance 50 may be readily produced in a die during manufacture of the retainer 40. Although only one dimple 50 is disclosed and displayed with respect to the described embodiment, each of the legs 44 may include additional dimples as deemed appropriate in a given application for achieving desired frictional retention forces on a valve guide.

The retainer 40 is designed so that the legs 44 collectively have a particular radial flexibility for accommodating a wide valve guide diameter tolerance range. This is achieved by controlling amount of circumferential arc dimension of each leg, circumferential spacing of the legs 44 from one another, length of the legs, the number of legs, and retainer material thickness. In the described embodiment, each leg defines an arc of at least 20 to 30 degrees of the 360-degree circumference of the retainer 40 to provide an effective balance between radial flexibility and axial stiffness of the retainer structure. The intent is to optimize ability of the collective legs 44 to be installed over a valve guide 12 of wide tolerance, while assuring appropriate axial stiffness of the retainer so that it will not fold over upon itself, or otherwise bend along the axis b-b, upon an attempted installation over a valve guide 12.

Finally, in the described embodiment, the retainer 40 is formed of spring metal material, and is ideally formed of spring steel. Such a material will assure adequate resilience of the dimples 50 for their satisfactory frictional retention against the outer circumferential surface 38 of the valve guide 12, as well as the appropriate resiliency of the legs 44 for achieving described purposes.

It is to be understood that the above description is intended to be illustrative, and not limiting. Many embodiments will be apparent to those of skill in the art upon reading the above description. The scope of the invention should be determined, however, not with reference to the above description, but with reference to the appended claims and the full scope of equivalents to which the claims are entitled by law.

What is claimed is:

1. A valve stem seal assembly adapted for insertion over a valve guide having a reciprocally moveable valve stem supported in the guide; said seal assembly comprising a cylindrical retainer having a longitudinal axis adapted for alignment with the stem and the guide, said cylindrical retainer comprising an upper annular body having a plurality of circumferentially spaced, axially extending legs depending from said upper body, wherein said legs comprise radially inwardly projecting protuberances adapted to engage an outer circumferential surface of the valve guide, wherein the guide surface is contacted only via said protuberances, whereby the leg surfaces apart from said protuberances are spaced from said guide surfaces by a gap defined by the radial dimensions of said protuberances.

2. The valve stem seal assembly of claim 1 wherein said upper body of said retainer comprises a radially oriented annular end wall integral therewith, and defining an upper extremity of said body, said end wall oriented orthogonally to said axis; said seal assembly further comprising an annular resilient valve stem seal body adapted for sealingly engaging the reciprocally movable valve stem; and wherein said valve stem seal has an exterior groove circumferentially disposed for engaging said annular end wall, whereby said seal is supported in said cylindrical retainer.

3. The valve stem seal assembly of claim 2 wherein said plurality of axially depending legs is adapted to be uniformly circumferentially disposed about the retainer body.

4. The valve stem seal assembly of claim 1 wherein each of said plurality of circumferentially axially depending legs comprises a single protuberance, and wherein at least one of said protuberances comprises a dimple having the general shape of a hemisphere.

5. The valve stem seal assembly of claim 4 wherein said plurality of said legs comprises a radial flexibility in said retainer for accommodating a wide valve guide diameter tolerance range.

6. The valve stem seal assembly of claim 2 wherein said resilient valve stem seal body is formed of an elastomeric material.

7. The valve stem seal assembly of claim 6 wherein said retainer is formed of a spring metal material.

8. The valve stem seal assembly of claim 7 wherein said plurality of axially depending legs comprise at least three legs uniformly circumferentially disposed about the valve guide.

9. The valve stem seal assembly of claim 5 wherein said dimples are adapted to provide the only direct contact of the legs with the valve guide surface.

10. The valve stem assembly of claim 9 wherein said legs are adapted to flex radially outwardly under a radially directed spring tension, and whereby said legs are adapted to hold said dimples in constant engagement with the valve guide.
